(19) United States
(12) Patent Application Publication
(10) Pub. No.: US 2014/0007672 A1
(43) Pub. Date: Jan. 9, 2014

(54) System for a Deep Water-Well Gauge

(71) Applicant: Thomas W. NEWTON, Midlothian, VA (US)

(72) Inventor: Thomas W. NEWTON, Midlothian, VA (US)

(21) Appl. No.: 13/910,112

(22) Filed: Jun. 4, 2013

Related U.S. Application Data
(60) Provisional application No. 61/655,357, filed on Jun. 4, 2012.

(51) Int. Cl. G01F 23/22

(52) U.S. Cl. CPC G01F 23/22
USPC 73/290 R

(57) ABSTRACT

A system for a deep water-well gauge is used to determine the volume of the remaining water within a deep water-well. A laser rangefinder is mounted to the top of the deep water-well and allows the system to measure the distance from the top of the deep water-well to the top surface of the volume of remaining water. This distance is known as the static water level, which can be viewed by a user through a display panel. The user can then input the static water level and the known dimensions of the deep water-well into a conversion chart in order to get a value for the volume of the remaining water. Both the display panel and the laser rangefinder are powered by a portable power source such as a battery.

The current application claims a priority to the U.S. Provisional Patent application Ser. No. 61/655,357 filed on Jun. 4, 2012.

### FIELD OF THE INVENTION

The present invention relates generally to a measuring apparatus for wells. More specifically, the apparatus is a gauge for determining the amount of water in a deep well (from 100 to 500 ft).

### BACKGROUND OF THE INVENTION

Currently there is no convenient or effective method to determine the amount of water in a deep well, beyond 100 feet. It is therefore an object of the present invention to provide an apparatus for measuring deep wells. The present invention is a gauge for determining the amount of water in a deep well, which is any well that is 100 ft. to 500 ft. deep.

### BRIEF DESCRIPTION OF THE DRAWINGS

FIG. 1 is a schematic view of the present invention at different levels: ground level, water level, and bottom of the well.

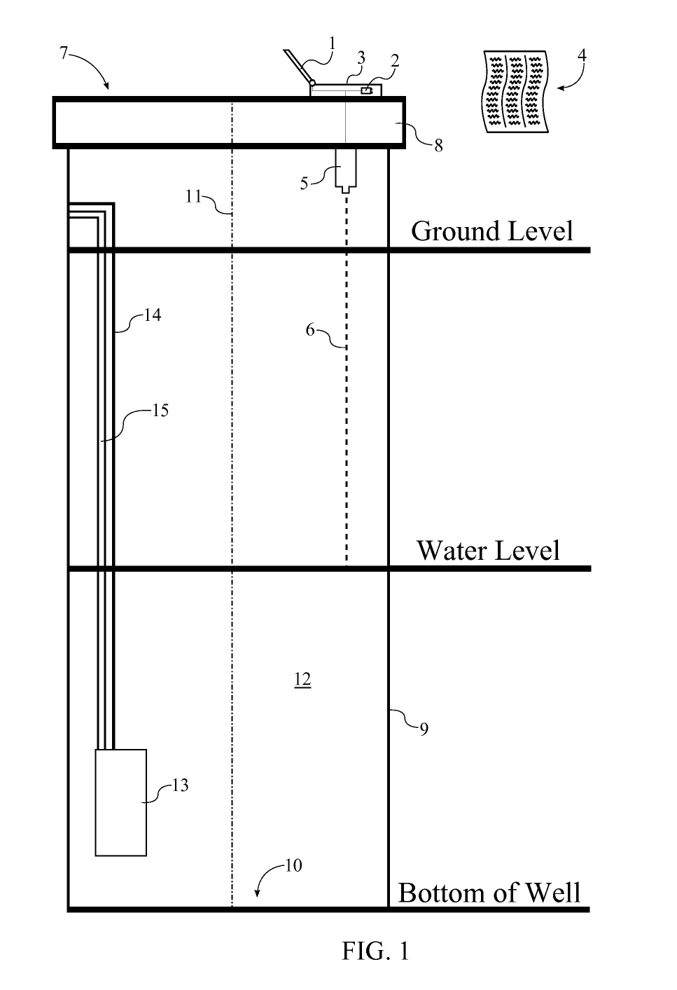

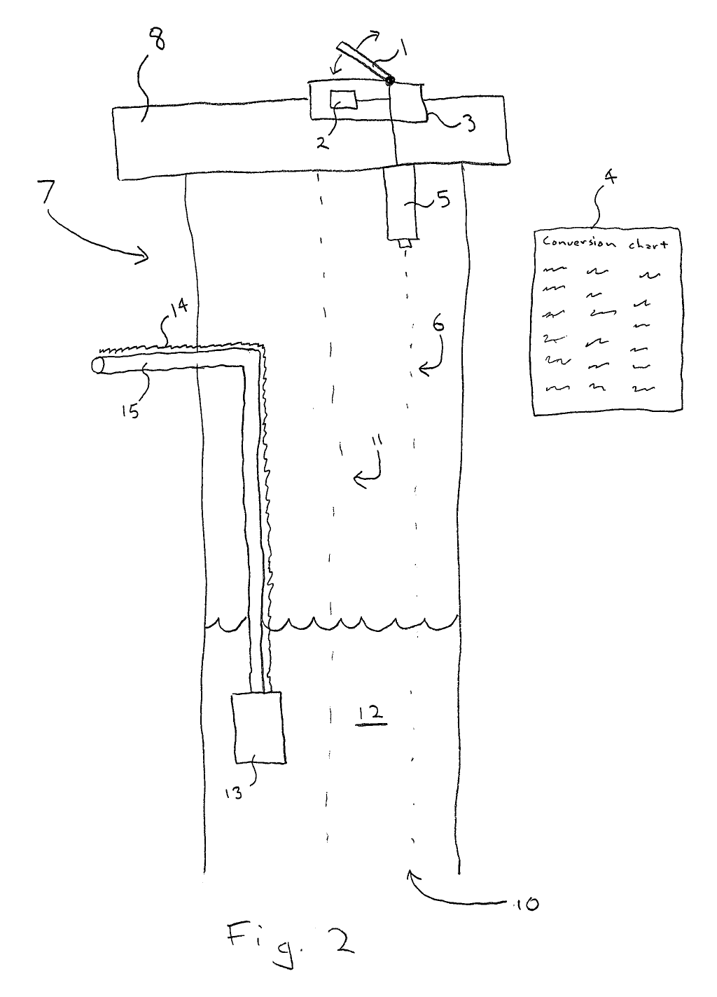

### DETAILED DESCRIPTIONS OF THE INVENTION

All illustrations of the drawings are for the purpose of describing selected versions of the present invention and are not intended to limit the scope of the present invention.

The present invention is a system for a deep water-well gauge and is used to determine the volume of remaining water within a deep well by finding the distance between the top of the deep well and the top surface of the volume of remaining water. Thus, the present invention can be used to effectively regulate water usage for the deep well and to alert a user if the deep well is leaking. The system for a deep water-well mainly comprises a display panel 1, a portable power source 2, a weatherproof housing 3, a conversion chart 4, a laser rangefinder 5, a deep water-well 7, and a volume of water 12. The present invention is specifically designed for a deep water-well 7 with a volume of water 12 flowing in from a confined aquifer. The laser rangefinder 5 is used to determine the distance between the top of the deep water-well 7 and the top surface for the volume of water 12, and this distance is known as the static water level. In the preferred embodiment of the present invention, the laser rangefinder 5 is designed for two ranges: up to 300 feet and up to 500 feet. The display panel 1 is easily accessible to a user and displays the measured distance from the laser rangefinder 5 as the static water level of the deep water-well 7. The portable power source 2 is a means to power the laser rangefinder 5 and the display panel 1. The weatherproof housing 3 is used to protect the electronic components of the present invention from outdoor exposure. The conversion chart 4 is a table of known values for different size water-wells, which can be used to convert the static water level into the volume of remaining water within the deep water-well 7.

The laser rangefinder 5 is able to detect the top surface for the volume of water 12 because the deep water-well 7 is a pitch black, confined enclosure. The deep water-well 7 comprises a closed top end 8, a lateral wall 9, an open bottom end 10, and a central longitudinal axis 11. The closed top end 8 and the open bottom end 10 being positioned opposite to each other along the deep water-well 7. The closed top end 8 is located above ground and is used to block light from entering the deep water-well 7. In one embodiment of the present invention, the closed top end 8 is a removable cover or cap for the deep water-well 7. The open bottom end 10 allows water to enter into the deep water-well 7 from the confined aquifer. The lateral wall 9 is perpendicularly positioned in between the closed top end 8 and the open bottom end 10. The lateral wall 9 is vertical tubing that traverses from the confined aquifer to above the ground and allows the deep water-well 7 to confine the volume of water 12. The lateral wall 9 is also positioned around the central longitudinal axis 11, which is an axis that travels lengthwise through the center of the deep water-well 7. The central longitudinal axis 11 is defined as a means to position other components of the present invention.

The orientation and configuration of the laser rangefinder 5 is important to detect the distance between the between the top of the deep water-well 7 and the top surface for the volume of water 12. The laser rangefinder 5 is mounted to the closed top end 8 so that the laser rangefinder 5 can accurately measure the total distance from the top of the deep water-well 7 to the top surface for the volume of water 12. The laser rangefinder 5 has a laser eye, which is oriented in such a way that the emission direction axis 6 of the laser rangefinder 5 is positioned toward the volume of water 12 and is parallel to the central longitudinal axis 11. This orientation for the laser rangefinder 5 allows the present invention to measure the shortest distance between the top of the deep water-well 7 and the top surface for the volume of the water 12, which is required to calculate a value for the volume of water 12.

The deep water-well 7 has a number of ancillary components that can interfere with the emission direction axis 6. The ancillary components include a water pump 13, a pump power cable 14, and a retrieval piping 15. The retrieval piping 15 is used transport water out of the deep water-well 7 and is in fluid communication with the water pump 13. The water pump 13 is submersed within the volume of water 12 and is positioned adjacent to the open bottom end 10 of the deep water-well 7 so that the water pump 13 is always submersed within the volume of water 12, even if the volume of water 12 is low. A pump power cable 14 is electrically connected to the water pump 13 as a means to transfer electrical power to the water pump 13. The pump power cable 14 is positioned along the retrieval pipe, which prevents clutter within the deep water-well 7. The emission direction axis 6 for the laser rangefinder 5 is positioned adjacent to both the retrieval piping 15 and the pump power cable 14 because those components are not always submersed within the volume of water 12.

The closed top end 8 is where the user would access and view the information provided by the present invention. Thus, the weatherproof housing 3 is integrated into the closed top end 8 in order to localize the display panel 1 and the portable power source 2 with the laser rangefinder 5. The portable power source 2 is located within the weatherproof housing 3 so that the portable power source 2 do not become damaged in wet or other harsh weather conditions. A user needs to be able to open the weatherproof housing 3 in order to replace or recharge the portable power source 2. The display panel 1 is positioned on the closed top end 8, outside of the deep water-well 7, which allows the user to easily access the display panel 1 when the user stands next to the deep water-well 7. The display panel 1 is hingedly connected to the weatherproof housing 3, which allows the user to open and close the display panel 1. When the display panel 1 is in the closed position, the display panel 1 does not display anything in order to conserve the portable power source 2. The display panel 1 will display the distance between the top of the deep water-well 7 and the top surface for the volume of water 12 as the static water level.

The present invention follows a specific algorithm in order to determine the volume of water 12 remaining in the deep water-well 7. The laser rangefinder 5 is electronically connected to the display panel 12 as a means of communicating the static water level measured by the laser rangefinder 5 to the display panel 12. The display panel 12 allows a user to view the static water level of the deep water-well 7. The user could determine the volume of remaining water with the static water level and a set of known values, which include the total length and the cross-sectional area of the internal cavity for the deep water-well 7. The user will subtract the static water level from the total length of the deep water-well 7 in order to find the height of the remaining water. The user will then multiply the height of the remaining water by the cross-sectional area of the internal cavity in order to finally determine the volume of the remaining water. However, the present invention circumvents this algorithm by providing the conversion chart 4, which will include a static water level, known dimensions, and the volume of remaining water for a plurality of different size water-wells. The portable power source 2 is electrically connected to the laser rangefinder 5 and the display panel 1 as a means to power these components while the present invention retrieves and displays the static water level. In the preferred embodiment, the portable power source 2 is a 9-volt battery.

The present invention is designed to be installed by a professional well contractor. After the present invention is installed on the deep water-well 7, then the only required maintenance of the present invention is a periodic battery check.

Although the invention has been explained in relation to its preferred embodiment, it is to be understood that many other possible modifications and variations can be made without departing from the spirit and scope of the invention as hereinafter claimed.

What is claimed is:

1. A system for a deep water-well gauge comprises:
a display panel;
a portable power source;
a weatherproof housing;
a conversion chart;
a laser rangefinder;
a deep water-well;
a volume of water; and
said deep water-well comprises a closed top end, a lateral wall, an open bottom end, and a central longitudinal axis.

2. The system for a deep water-well gauge as claimed in claim 1 comprises:
said closed top end and said open bottom end being positioned opposite of each other along said deep water-well;
said lateral wall being perpendicularly positioned in between said closed top end and said open bottom end;
said lateral wall being positioned around said central longitudinal axis; and
said volume of water being confined by said lateral wall.

3. The system for a deep water-well gauge as claimed in claim 1 comprises:
said laser rangefinder being mounted to said closed top end within said deep water-well;
an emission direction axis of said laser rangefinder being positioned towards said volume of water; and
said emission direction axis being positioned parallel to said central longitudinal axis.

4. The system for a deep water-well gauge as claimed in claim 3 comprises:
a water pump being positioned adjacent to said open bottom end within said volume of water;
a retrieval pipe being in fluid communication with said water pump;
a pump power cable being electrically connected to said water pump;
said pump power cable being positioned along said retrieval piping; and
said emission direction axis being positioned adjacent to both said retrieval piping and said pump power cable.

5. The system for a deep water-well gauge as claimed in claim 1 comprises:
said weatherproof housing being integrated into said closed top end;
said portable power source being located within said weatherproof housing;
said display panel being hingedly connected to said weatherproof housing; and
said display panel being positioned on said closed top end outside of said deep water-well.

6. The system for a deep water-well gauge as claimed in claim 1 comprises:
said laser rangefinder being electronically connected to said display panel; and
said portable power source being electrically connected to said laser rangefinder and said display panel.

7. A system for a deep water-well gauge comprises:
a display panel;
a portable power source;
a weatherproof housing;
a conversion chart;
a laser rangefinder;
a deep water-well;
a volume of water;
said deep water-well comprises a closed top end, a lateral wall, an open bottom end, and a central longitudinal axis;
said laser rangefinder being mounted to said closed top end within said deep water-well;
an emission direction axis of said laser rangefinder being positioned towards said volume of water; and
said emission direction axis being positioned parallel to said central longitudinal axis.

8. The system for a deep water-well gauge as claimed in claim 7 comprises:
said closed top end and said open bottom end being positioned opposite of each other along said deep water-well;
said lateral wall being perpendicularly positioned in between said closed top end and said open bottom end;
said lateral wall being positioned around said central longitudinal axis; and
said volume of water being confined by said lateral wall.

9. The system for a deep water-well gauge as claimed in claim 7 comprises:
a water pump being positioned adjacent to said open bottom end within said volume of water;
a retrieval pipe being in fluid communication with said water pump;
a pump power cable being electrically connected to said water pump;
said pump power cable being positioned along said retrieval piping; and
said emission direction axis being positioned adjacent to both said retrieval piping and said pump power cable.

10. The system for a deep water-well gauge as claimed in claim 7 comprises:
said weatherproof housing being integrated into said closed top end;
said portable power source being located within said weatherproof housing;
said display panel being hingedly connected to said weatherproof housing; and
said display panel being positioned on said closed top end outside of said deep water-well.

11. The system for a deep water-well gauge as claimed in claim 7 comprises:
said laser rangefinder being electronically connected to said display panel; and
said portable power source being electrically connected to said laser rangefinder and said display panel.

12. A system for a deep water-well gauge comprises:
a display panel;
a portable power source;
a weatherproof housing;
a conversion chart;
a laser rangefinder;
a deep water-well;
a volume of water;
said deep water-well comprises a closed top end, a lateral wall, an open bottom end, and a central longitudinal axis;
said laser rangefinder being mounted to said closed top end within said deep water-well;
an emission direction axis of said laser rangefinder being positioned towards said volume of water;
said emission direction axis being positioned parallel to said central longitudinal axis;
said weatherproof housing being integrated into said closed top end;
said portable power source being located within said weatherproof housing;
said display panel being hingedly connected to said weatherproof housing;
said display panel being positioned on said closed top end outside of said deep water-well;
said laser rangefinder being electronically connected to said display panel; and
said portable power source being electrically connected to said laser rangefinder and said display panel.

13. The system for a deep water-well gauge as claimed in claim 12 comprises:
said closed top end and said open bottom end being positioned opposite of each other along said deep water-well;
said lateral wall being perpendicularly positioned in between said closed top end and said open bottom end;
said lateral wall being positioned around said central longitudinal axis; and
said volume of water being confined by said lateral wall.

14. The system for a deep water-well gauge as claimed in claim 12 comprises:
a water pump being positioned adjacent to said open bottom end within said volume of water;
a retrieval pipe being in fluid communication with said water pump;
a pump power cable being electrically connected to said water pump;
said pump power cable being positioned along said retrieval piping; and
said emission direction axis being positioned adjacent to both said retrieval piping and said pump power cable.
